(19) United States
(12) Patent Application Publication
(10) Pub. No.: US 2019/0391021 A1
(43) Pub. Date: Dec. 26, 2019

(54) FIXING STRUCTURE OF TEMPERATURE SENSOR FOR VEHICLE

(71) Applicants: HYUNDAI MOTOR COMPANY, Seoul (KR); KIA MOTORS CORPORATION, Seoul (KR); INZICONTROLS CO., LTD., Siheung-si (KR)

(72) Inventors: Choo Saeng CHOI, Seongnam-si (KR); Kwang Heon LEE, Gwangmyeong-si (KR); Sang Joon PARK, Ansan-si (KR)

(73) Assignees: HYUNDAI MOTOR COMPANY, Seoul (KR); KIA MOTORS CORPORATION, Seoul (KR); INZICONTROLS CO., LTD., Siheung-si (KR)

(21) Appl. No.: 16/214,364

(22) Filed: Dec. 10, 2018

(30) Foreign Application Priority Data
Jun. 25, 2018 (KR) 10-2018-0072862

(51) Int. Cl. G01K 1/14; G01K 7/22

(52) U.S. Cl. CPC G01K 1/14; G01K 7/22

(57) ABSTRACT

A fixing structure of a temperature sensor for a vehicle includes: a mounting bracket including one end to support a temperature sensor that senses a temperature of a cooling medium and the other end engaged with an object to be fixed. In particular, a polygonal-shaped coupling portion is formed in the temperature sensor, and a polygonal-shaped fit-coupling groove is formed in the bracket to couple with the polygonal-shaped coupling portion. Accordingly, a layout for mounting the temperature sensor can be improved, while enabling universal applicability to all vehicle types.

### CROSS-REFERENCE TO RELATED APPLICATION

This application claims priority to and the benefit of Korean Patent Application No. 10-2018-0072862, filed on Jun. 25, 2018, the entire contents of which are incorporated herein by reference.

### FIELD

The present disclosure relates to a fixing structure of a temperature sensor for a vehicle. More particularly, the present disclosure relates to a fixing structure of a temperature sensor to stably fix the temperature sensor to a target.

### BACKGROUND

The statements in this section merely provide background information related to the present disclosure and may not constitute prior art.

In general, a temperature sensor for a vehicle is utilized to control an engine by measuring a temperature (e.g., a temperature of coolant antifreeze) of a cooling medium of the engine. Such a temperature sensor is mounted to an object to be measured in a way of being planted a measurement object to measure a temperature of the cooling medium. Here, the measurement object may be formed in the shape of a tube or a pipe that form a path of the cooling medium.

In order to mount such a conventional temperature sensor to the object to be measured, a clip may be used or a screw is formed in the temperature sensor to screw-engage the temperature sensor to the measurement object.

However, we have discovered that in a clip-type or screw-type temperature sensor mounting structure, when the temperature sensor is fixed by using a clip to prevent the temperature sensor from falling into a measurement object, the clip may rotate in any direction since the clip cannot control a rotation direction and thus the clip cannot maintain a stable mounting posture, and accordingly it may be difficult to connect a connector for receiving a sense signal of the temperature sensor to the temperature sensor due to a layout.

We have also discovered that when a layout of the periphery of the mounting of the temperature sensor is changed for each vehicle type, the mounting structure needs to be change because the mounting structure cannot be properly cope with the layout change.

The above information disclosed in this Background section is only for enhancement of understanding of the background of the present disclosure and therefore it may contain information that does not form the prior art that is already known to a person of ordinary skill in the art.

### SUMMARY

The present disclosure provides a fixing structure of a temperature sensor for a vehicle, which enables to easily insert the temperature sensor into a measurement object and easily change the fixed portion of the temperature sensor according to a layout of the mounting periphery so that the mounting work of the temperature sensor becomes convenient and universal, and the mounting posture of the temperature sensor can be stably maintained.

In one form of the present disclosure, a fixing structure of a temperature sensor for a vehicle may include: a mounting bracket including a first end configured to support a temperature sensor to sense a temperature of a cooling medium and a second end engaged with an object to be fixed. In particular, a polygonal-shaped coupling portion is formed in the temperature sensor; and a polygonal-shaped fit-coupling groove is formed in the bracket and configured to couple with the polygonal-shaped coupling portion of the temperature sensor.

The polygonal-shaped coupling portion and the polygonal-shaped fit-coupling groove may be an octagonal shape.

The mounting bracket may include: a bracket body including the polygonal-shaped fit-coupling groove formed at one side; and an assembly hole formed at the other side of the bracket body while penetrating therethrough.

The polygonal-shaped fit-coupling groove may include: a bottom surface; two side surfaces that extend from the bottom surface and face each other, and thus the polygonal-shaped fit-coupling groove may be formed in the shape of “U′ by the bottom surface and the two side surfaces.

When the polygonal-shaped coupling portion is coupled to the polygonal-shaped fit-coupling portion by being inserted thereinto, at least one fixing protrusion may be further provided in the mounting bracket to inhibit or prevent the polygonal-shaped coupling portion from being separated.

Fixing protrusions that protrude to the inside of the polygonal-shaped fit-coupling groove may be provided at the two side surfaces.

The temperature sensor may include: a connector base to which a connector is coupled by being inserted thereinto to transmit the sensed temperature of the cooling medium; a terminal provided in the connector base; a temperature sensor body coupled to the connector base; a thermistor that is inserted into the temperature sensor to sense the temperature of the cooling medium; and the polygonal-shaped coupling portion is formed in the connector base.

As described, in the fixing structure of the temperature sensor for the vehicle according to the exemplary form of the present disclosure, the octagonal-shaped coupling portion is provided in the temperature sensor body and the octagonal-shaped fit-groove is provided for being fit-coupled with the coupling portion in the mounting bracket that mounts the temperature sensor to the measurement object, and thus the mounting bracket and the temperature sensor can be coupled at various angles at eight orientations. Accordingly, the temperature sensor can be easily coupled with the mounting bracket without regard to a limited layout at the mounting periphery of the temperature sensor.

In addition, at least one fixing protrusion is provided in an inner wall that forms the fit-groove of the mounting groove to prevent the coupling portion of the temperature sensor from being separated, and thus coupling force between the temperature sensor and the mounting bracket can be improved, and mounting posture of the temperature sensor can be stably maintained.

Since the temperature sensor can be fixed by fitting the mounting bracket into the temperature sensor in various orientations, and accordingly the fixing structure can be universally applied to all vehicle types, regardless of layout of the vehicle.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 is a cross-sectional view of a fixing structure of a temperature sensor for a vehicle according to an exemplary form of the present disclosure;

FIG. 2 is a top plan view and a side view of a mounting bracket of the temperature sensor for the vehicle according to the exemplary form of the present disclosure;

FIG. 3 is a top plan view of the fixing structure of the temperature sensor for the vehicle according to the exemplary form of the present disclosure; and

FIG. 4 is provided to describe engagement of the mounting bracket and the temperature sensor for the vehicle in various orientations according to the exemplary form of the present disclosure.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

As those skilled in the art would realize, the described forms may be modified in various different ways, all without departing from the spirit or scope of the present disclosure.

The drawings and description are to be regarded as illustrative in nature and not restrictive.

Since the size and the thickness of each configuration shown in the drawings are arbitrarily indicated for better understanding and ease of description, the present disclosure is not limited to shown drawings, and the thickness of layers, films, panels, regions, etc., are exaggerated for clarity.

Hereinafter, a fixing structure of a temperature sensor for a vehicle according to an exemplary form of the present disclosure will be described in detail with reference to the accompanying drawing.

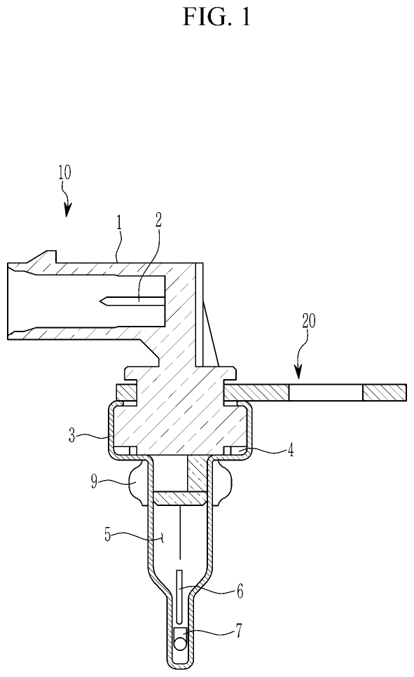

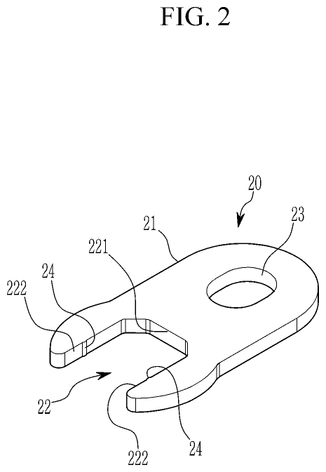

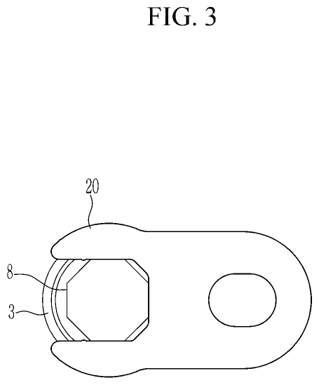

Referring to FIG. 1 to FIG. 3, a temperature sensor 10 to which a fixing structure of a temperature sensor for a vehicle according to an exemplary form of the present disclosure is applied, may include a connector base 1 and a terminal 2. The connector base 1 is coupled with a connector of another device in a way of being inserted therein for transmitting a temperature sense signal of a coolant medium to the other device, the terminal 2 is provided in the connector base 1.

A temperature sensor body 3 may be coupled to the connector base 1. When the temperature sensor body 3 and the connector base 1 are coupled, a seal such as an O-ring may be provided therebetween to maintain air-tightness therebetween.

A hollow portion 5 having an empty inside such as a pipe is provided in the temperature sensor body 3, a grease 6 is inserted into a front end portion of the following portion 5, and a thermistor 7, which is a semiconductor element sensing a temperature of a temperature sensing medium, is inserted into the front end portion of the hollow portion 5. When a temperature sensor 10 is mounted in a way of insertion by forming a mounting hole in an object to be fixed, an outer side ring 9 such as an O-ring may be attached to an external circumference of the temperature sensor body 3 to maintain airtightness of the mounting hole.

A polygonal, in one form, octagonal-shaped coupling portion 8 is formed at a predetermined portion of the connector base 1, and the mounting bracket 20 may be coupled to the coupling portion 8.

The shape of the coupling portion 8 is not limited to the octagon, and may be formed in the shape of a polygon as desired.

The mounting bracket 20 may include a bracket body 31, a fit-coupling groove 22 that is formed at one side of the bracket body 21, and an assembly hole 23 that is formed at the other side of the bracket body 21 while penetrating therethrough.

The fit-coupling groove 22 may be substantially formed in the shape of “U”, and at least one of fixing protrusions 24 that protrude to the inside of the fit-coupling groove 22 may be provided at a side wall of the fit-coupling groove 22.

In one form, a width of the fit-coupling groove 22 may be almost equal to a width of the coupling portion 8.

The fit-coupling groove 22 may include one bottom side 221 and two side surfaces 222 that are opposite to each other and symmetrical to each other.

In another form, the fixing protrusions 24 are provided as a pair at locations that facing each other, but this is not restrictive. A gap between the fixing protrusions 24 may be formed to be smaller than a width of the coupling portion 8.

When the coupling portion 8 of the temperature sensor 10 is inserted into the fit-coupling groove 22 of the mounting bracket 20, the polygonal shape of the fit-coupling groove 22 and the polygonal shape of the coupling portion 8 interact with each other such that relative rotation of the mounting bracket 20 and the temperature sensor 10 can be prevented.

That is, when the coupling portion 8 of the temperature sensor 10 is coupled to the mounting bracket 20 by being inserted into the fit-coupling groove 22 of the mounting bracket 20, side surfaces of the coupling portion 8 of the temperature sensor 10 contact the bottom surface 221 and the two side surfaces 222 of the fit-coupling groove 22 such that the temperature sensor 10 coupled to the fit-coupling groove 22 of the mounting bracket 20 can be prevented from rotating by interaction between the contacting surfaces.

In addition, the fixing protrusions 23 may inhibit or prevent the temperature sensor 10 coupled to the fit-coupling groove 22 of the mounting bracket 20 from being separated.

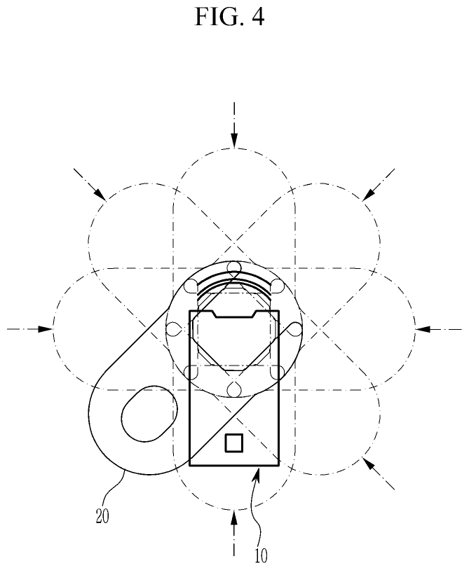

Referring to FIG. 4, the temperature sensor 10 and the mounting bracket 20 can be coupled with each other at various orientations.

That is, the mounting bracket 20 may be selectively coupled with respect to the temperature sensor 10 at seven orientations in a clockwise or counter-clockwise direction with an angle of 45 degrees. Accordingly, when the temperature sensor 10 is mounted to the object to be fixed, even though a layout of a portion where the mounting is carried out is limited, a proper coupling orientation is selected to couple the mounting bracket 20 to the temperature sensor 20, and accordingly, a fixing location of the temperature sensor 10 can be various modified, and even if layers differ depending on a vehicle type, the fixing location can be appropriately coped.

While this present disclosure has been described in connection with what is presently considered to be practical exemplary forms, it is to be understood that the present disclosure is not limited to the disclosed forms, but, on the contrary, is intended to cover various modifications and equivalent arrangements included within the spirit and scope of the present disclosure.

### DESCRIPTION OF SYMBOLS

1: connector base
2: terminal
3: temperature sensor body
4: seal
5: hollow portion
6: grease
7: thermistor
8: coupling portion
9: outer side ring
10: temperature sensor
20: mounting bracket
21: bracket body
22: fit-coupling groove
23: assembly hole
24: fixing protrusion

What is claimed is:

1. A fixing structure of a temperature sensor for a vehicle, the fixing structure comprising:
a mounting bracket including a first end configured to support a temperature sensor configured to sense a temperature of a cooling medium, and a second end configured to engage with an object to be fixed,
wherein a polygonal-shaped coupling portion is formed in the temperature sensor; and
a polygonal-shaped fit-coupling groove is formed in the bracket and configured to couple with the polygonal-shaped coupling portion of the temperature sensor.

2. The fixing structure of claim 1, wherein the polygonal-shaped coupling portion and the polygonal-shaped fit-coupling groove are an octagonal shape.

3. The fixing structure of claim 2, wherein the mounting bracket comprises:
a bracket body including the polygonal-shaped fit-coupling groove formed at one side; and
an assembly hole formed at other side of the bracket body while penetrating therethrough.

4. The fixing structure of claim 3, wherein the polygonal-shaped fit-coupling groove comprises:
a bottom surface;
two side surfaces extended from the bottom surface and configured to face each other, and
the polygonal-shaped fit-coupling groove is formed in a shape of “U′ by the bottom surface and the two side surfaces.

5. The fixing structure of claim 1, wherein when the polygonal-shaped coupling portion is coupled to the polygonal-shaped fit-coupling portion by being inserted thereinto, at least one fixing protrusion is further provided in the mounting bracket and configured to inhibit the polygonal-shaped coupling portion from being separated.

6. The fixing structure of claim 4, wherein fixing protrusions that protrude to an inside of the polygonal-shaped fit-coupling groove are provided at the two side surfaces.

7. The fixing structure of claim 1, wherein the temperature sensor comprises:
a connector base to which a connector is coupled by being inserted thereinto to transmit the sensed temperature of the cooling medium;
a terminal provided in the connector base;
a temperature sensor body coupled to the connector base;
a thermistor that is inserted into the temperature sensor to sense the temperature of the cooling medium; and
wherein the polygonal-shaped coupling portion is formed in the connector base.
